(19) United States
(12) Patent Application Publication
(10) Pub. No.: US 2021/0090463 A1
(43) Pub. Date: Mar. 25, 2021

(54) METHOD AND SYSTEM FOR TRAINING NON-TECHNICAL USERS ON HIGHLY COMPLEX CYBER SECURITY TOPICS

(71) Applicant: Circadence Corporation, Boulder, CO (US)

(72) Inventors: Phillip Atencio, Boulder, CO (US); Cassie Brubaker, Boulder, CO (US); Peter Grundy, Boulder, CO (US); Brandon Dorris, Boulder, CO (US); Michael Moniz, Boulder, CO (US)

(21) Appl. No.: 17/014,849

(22) Filed: Sep. 8, 2020

Related U.S. Application Data
(60) Provisional application No. 62/897,861, filed on Sep. 9, 2019.

(51) Int. Cl. G09B 19/00; A63F 13/80; H04L 29/06; G06N 20/00

(52) U.S. Cl. CPC G09B 19/0053; A63F 13/80; H04L 63/20; G06Q 10/06398; G06N 20/00; A63F 2300/8094; H04L 63/1433

(57) ABSTRACT

Systems and methods are provided for presenting a cybersecurity training game to one or more players. The game comprises a turn-based game in which two players take turns playing entities, such as game cards, which have attributes or effects. Each player's objective is to attack and destroy one or more devices belonging to the other player/opponent and set up defenses to mitigate attacks on their own devices, so that the player destroys the devices belonging to the other player/opponent before the other player/opponent attacks and destroys their own devices, using game cards that are dealt to or acquired by them.

### RELATED APPLICATION DATA

This application claims priority to U.S. Provisional Application Ser. No. 62/897,861, filed Sep. 9, 2019, which is incorporated herein in its entirety by reference.

### FIELD OF THE INVENTION

Embodiments of the present invention relates to a cyber security training system and methods for train non-technical employees on highly complex cyber security topics.

### BACKGROUND OF THE INVENTION

Many data breaches begin by exploiting an organization's employees in order to gain access to protected systems and private information. Many such exploits take advantage of human nature to gain access. For example, a social engineering attack tries to leverage societal norms and their target's innate desire to appear helpful, friendly, or intelligent to cause the target to reveal private information. Similarly, a phishing attack may attempt to create a sense of urgency, fear, or panic in the recipient of an email that causes the target to visit the attacker's malicious website, thus leading to a breach. Or, an attacker may use information gained from social media or from a prior, unrelated breach to gain access, relying on the tendency of people to create memorable passwords and reuse the same password on multiple sites.

No matter the specific vector, the human element in breaches is well documented. Therefore, a key component of any organization's cybersecurity defense program must be to make employees aware of the multifarious threats and provide them with the tactics, techniques, and procedures to individually guard against these human-centric threats.

Security awareness is a significant and important challenge for organizations, whether commercial, academic, or government. However, while the need for increased understanding of security concepts and hygiene in the workforce has been understood and publicized for years, instilling effective security awareness in the workforce remains an important security industry problem. Therefore, effective employee cybersecurity awareness training that leads to improved decisions in handling sensitive data, social media, web hygiene, and other behaviors is amongst the most important tools an organization has to improve its defensive posture.

Currently, cybersecurity training, awareness, and enforcement programs for members of an organization's general workforce tend to use a three-part program, including classroom training, formal assessments and live training. Classroom training has been used to inform employees about threats and best-practices for defense. These can be delivered in a “live” or “self-directed” format and may be online or in-person, though most often these courses are delivered as PowerPoint presentations or pre-recorded videos. Often, organizations will do an initial training during onboarding followed up by refresher briefings (generally annual) that seek to update employees with new information and/or reinforce organizational policies.

Typically coupled with classroom training, formal assessments seek to ensure that employees can recall and recite the information provided in the classroom training. These assessments are generally provided as short, online multiple-choice tests that are graded in real-time, and employees must usually receive an organizationally-defined “passing grade” in order to receive credit for their training. Often, employees who fail to meet the scoring criteria are given an opportunity to retake the test until they pass, and failure to complete training with a passing grade generally results in disciplinary action. While most professionals agree that these assessments do not provide much or any value, they are often required to fulfill an organization's metrics-based compliance obligations.

Periodically, organizations will conduct live training/testing exercises that attempt to reinforce safe cybersecurity behaviors and/or uncover workforce security weaknesses by placing employees into controlled, semi-realistic attack situations and testing their response. This type of exercise most commonly takes the form of a simulated phishing campaign, an exercise where the organization sends phishing emails to its own employees in order to give users a realistic but safe way to improve their phishing detection skills. Users who ignore or report the email (if such reporting tools exist) effectively “pass” the training, while those users who open the payload “fail” the training and may be subject to refresher training, discipline, or more-frequent live exercises. Many third-party services exist to facilitate this and other types of live training exercises for the general workforce.

Prior products provide a suite of tools to facilitate classroom training, formal assessment, live testing, and results analysis, and to integrate with the organization's learning management systems (LMS), but they all suffer from a common set of problems. Classroom training and assessment programs, whether developed in-house or provided by third-parties specializing in such training, vary greatly across organizations and providers in terms of quality and effectiveness. These programs run the gamut from simple “compliance training” to practical steps users can take to improve their cybersecurity defensive posture. Most third-party products exist to serve companies that are either at the second (compliance) or third level (awareness) of the Security Awareness Maturity Model as developed by SANS.org.

With few exceptions, existing training products and programs use a boring, passive, and unengaging presentation format that leads to lower retention, rather than an engaging, memorable, and enjoyable format that would lead to better retention. Even the existing products that attempt to “gamify” the learning experience do so with rudimentary “game” mechanics, such as “choose your own adventure”-style stories or “Jeopardy!”-style rapid-fire knowledge checks. These attempts at gamification only provide a subtle enhancement over what is essentially rote memorization. Additionally, most existing programs include threat information and defensive techniques that are outdated, unrealistic, or irrelevant, and they do not convey practical, actionable information that members of the general workforce can use to defend themselves on a daily basis.

The effectiveness of security awareness training programs is generally measured either through formal evaluations that do not adequately predict the performance of trainees against realistic threats or through live exercises that focus too heavily on a single threat vector (usually phishing). While some products exist to address other threat vectors, these products are far less common and still fail to address the practical reality of the dynamic, evolving threat landscape in a meaningful way. Most security awareness programs rely too heavily on the “stick” (i.e., disciplinary action) to ensure compliance rather than on the “carrot” (i.e., intrinsic or extrinsic rewards) to foster cultural changes around security.

To address the cyber security threat and associated risk many companies have deployed physical technology such as firewalls, security servers, and workforce procedures to keep hackers out of company resources. However, after deployment of technical solutions and enterprise wide training, hackers have still been able to gain access to sensitive company information and systems by leveraging the human element of the enterprise.

After studying the problem, most experts agree that the success of hackers most often occurs by way of the human element, or more specifically, the non-technical employees of the enterprise.

As such, hackers have shifted their primary entry means to non-technical attacks including attacks comprising phishing scams, social media access, and gaining access to personal information research focused on individual employees to work around a company's highly technical physical security and security processes. Such human-side hacking techniques have been very successful for hackers to gain entry into a company's sensitive information.

To address this issue, many companies have established traditional training programs in an attempt to train their workforce. Such training ranged from traditional classroom lectures, informational videos, briefings, and the like, with limited hands on training for the non-technical workforce.

Yet even with these attempts to train the non-technical workforce, hackers continued to successfully launch attacks and gain access to company resources.

With the limited success of legacy training methodologies, a new form of interactive training and workforce assessment is needed, going beyond the basic lecture-test-feedback approach to train non-technical workers.

The non-technical employee does not have personal experience with cyber attacks nor do they have any idea how such attacks work. The present invention demonstrates to users of the system how easy it is to be hacked so they can become motivated to learn cyber hygiene skills without having to become real life victims.

To solve this unique cybersecurity problem related to training and long-term comprehension of highly complex technical hacking topics for the company's non-technical workforce, a novel, interactive cybersecurity training toolset has been invented to systematically train non-technical workers using a novel system and methodology that uses a hands-on, interactive approach to navigate the cyber kill chain.

In all cases, programs and products for general workforce cybersecurity training typically result in less-than-optimal real-world results. However, because there are few or no higher quality alternatives, these suboptimal products represent the current state-of-the-art for general workforce cybersecurity training, meaning that even the best products leave skills and knowledge gaps that can be easily exploited by attackers.

The disclosed invention overcomes the above-described problems by providing a next generation hands-on training solution.

### SUMMARY OF THE INVENTION

Aspects of the invention comprise a system and method for presenting a cybersecurity training game to one or more players. In one embodiment, the game includes entities, such as game cards, wherein the entities have components, such as attributes or effects.

In one embodiment, the game comprises a turn-based game in which two players take turns playing cards. Each player's objective is to attack and destroy one or more devices belonging to the other player/opponent and set up defenses to mitigate attacks on their own devices, so that the player destroys the devices belonging to the other player/opponent before the other player/opponent attacks and destroys their own devices, using game cards that are dealt to or acquired by them. The players play game cards to implement defensive and offensive measures.

In one embodiment, a system for implementing cyber-security awareness training to a player in the form of a turn-based game comprises: a client device comprising a processor, a video display and a player input device; a system server comprising a system server processor and a system server memory, the system server in communication with the client device; non-transitory machine-readable code stored in the system server memory and executable by the system server processor of the system server to: (a) cause the client device to display a player game board, the player game board having a plurality of layers and at least one attackable asset of the player, and to display an opponent game board, the opponent game board having a plurality of layers and at least one attackable asset of the opponent; (b) cause the client device to display a player hand of one or more game cards, each of the game cards having at least one cyber-security related attribute; (c) to, in a plurality of alternating turns: (i) receive input from the player of the player device of one of the game cards to play; (ii) implement the at least one cyber-security related attribute associated with the played game card relative to one of the layers of the player game board or the opponent game board; and (iii) implement at least one cyber-security related attribute associated with at least one game card played by the opponent relative to one of the layers of the player game board or the opponent game board; and (d) determine the player to be a winner of the game when the player successfully attacks the at least one attackable asset of the opponent before the opponent successfully attacks the at least attackable asset of the player, and determine the opponent to be the winner of the game when the opponent successfully attacks the at least one attackable assets of the player before the player successfully attacks the at least one attackable asset of the player, wherein in order to successfully attack the at least one attackable asset of the player, the opponent must penetrate one or more layers of the player's game board via the at least one game card played by the opponent, and wherein in order to successfully attack the at least one attackable asset of the opponent, the player must penetrate one or more layers of the opponent's game board via the at least one game card played by the player.

In embodiment, the player's hand of one or more game cards comprises at least one of a game card dealt to the player and a game card acquired by the player from the opponent.

The layers of the game boards may comprise a skill layer, an information layer and an infiltration layer. One or more elements of player information are associated with the information layer of each player's game board, and in one embodiment, a player must obtain the one or more elements of the opponent information in order to attack the at least one attackable asset of the opponent, wherein the player obtains the elements of opponent information based upon the play of one or more of the game cards.

In one embodiment, the game cards which are used in the game are associated with a deck of game cards, where the game cards associated with the deck of game cards varies depending upon a cyber-security skill being trained. In one embodiment, the at least one cyber-security related attribute which is associated with each game card may comprise an offensive attribute or a defensive attribute.

Further objects, features, and advantages of the present invention over the prior art will become apparent from the detailed description of the drawings which follows, when considered with the attached figures.

### DESCRIPTION OF THE DRAWINGS

FIG. 1 illustrates an embodiment of a system in accordance with the invention;

FIG. 2 illustrates an embodiment of a data pipeline;

FIGS. 3A and 3B illustrate an embodiment of a detailed architecture of a system of the invention;

FIG. 4 is an example of a training campaign and associated game actions in accordance with an embodiment of the invention;

FIG. 5 illustrates an example graphically displayed game environment with player game boards;

FIG. 6 illustrates an example of a game card of the present invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

The disclosed system and methods are directed to the training of non-technical users on highly complex cybersecurity topics, such as core cybersecurity kill chain concepts, via an entertaining interactive game that teaches players to “learn by doing.”

In one embodiment, training is accomplished by presentation and play of a cybersecurity training game. In one embodiment, the game includes entities, such as game cards, wherein the entities have components, such as attributes or effects. Thus, in one embodiment, the game is presented and played using cards dealt to (or otherwise obtained by) each player, such as from a set of cards. The cards each have various associated attributes or effects which are associated with cybersecurity topics.

In one embodiment, the game comprises a turn-based game in which two players take turns playing cards. Each player's objective is to attack and destroy one or more devices which are capable of being accessed in an unauthorized manner or “hacked” (whereby such devices may be referred to as “hackables” herein) belonging to the other player/opponent and set up defenses to mitigate attacks on their own devices, so that the player destroys the devices belonging to the other player/opponent before the other player/opponent attacks and destroys their own devices, using game cards that are dealt to or acquired by them.

In one embodiment, game cards are assigned to zones and the assigned zone of a card is updated, such as based upon it being dealt or played. In one embodiment, a player is trained relative to a plurality of topics or “campaigns”, where each campaign has an associated set of game mechanics and actions which are unlocked for the campaign. Each set of actions is associated with one or more of the game cards.

In one embodiment, the game is played relative to a game board. The game board may comprise, relative to each player, a skill layer or zone, an information layer or zone, an infiltration or install layer or zone, and one or more devices. In one embodiment, a player applies their knowledge of cybersecurity topics to appropriately play their game cards, such as to associate skills with their skill layer that will block attacks by an opponent, play game cards to acquire information from an opponent and attack an opponent's devices, or block an opponent's attack on their devices.

General System

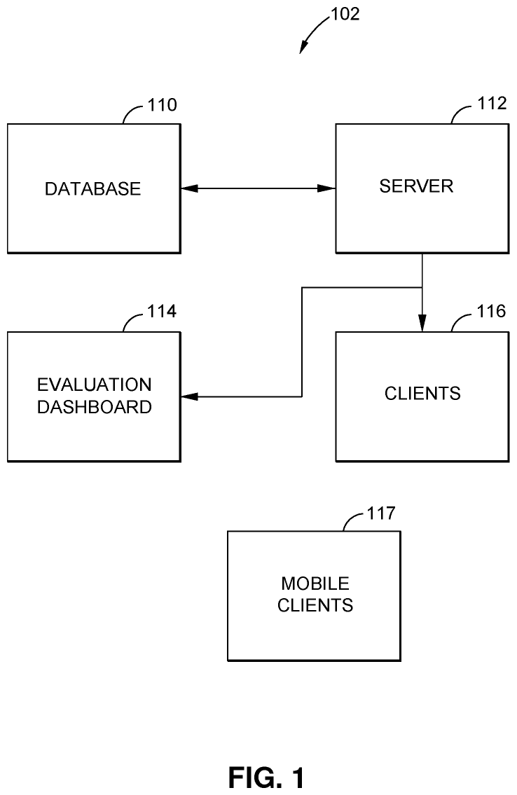

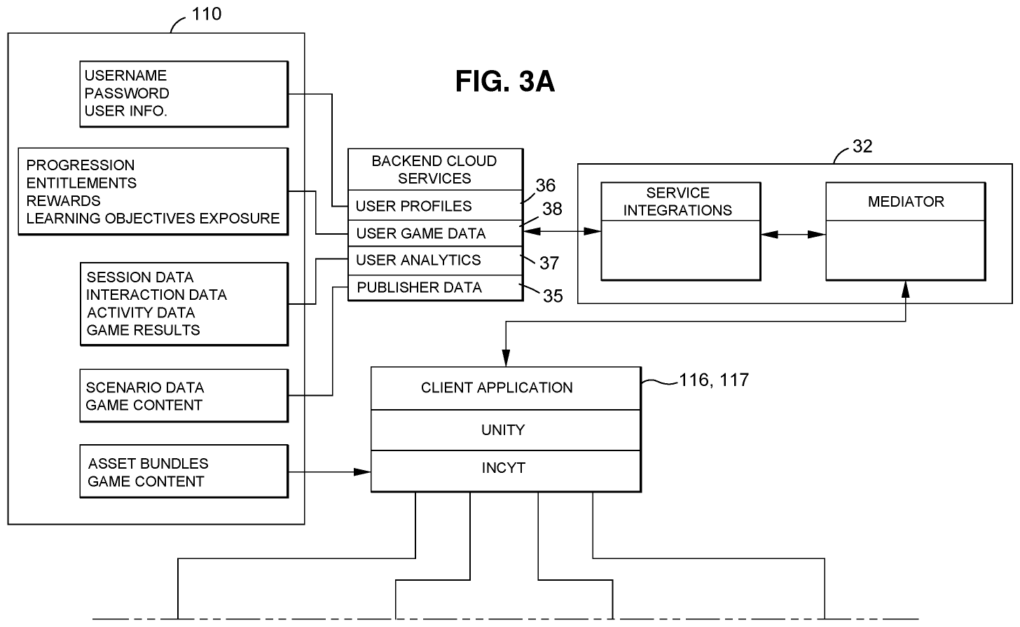

FIG. 1 illustrates a system 102 of the invention at a high level. As illustrated, in one embodiment, the system 102 comprises a database 110, a server 112 (such as a system server or game server), and a plurality of user interfaces 114 and clients or client devices 116, 117, to deliver cybersecurity training to non-technical users.

In one embodiment, the system 102 includes an application for electronic devices such as mobile phones or desktop computers which comprise the client devices 116, 117. This application (such as comprising software which is stored in a memory of the device and which is executable by a processor of the device) hosts the user's application interface and links to the server 112 to enable the user to play against an opponent.

Thus, one aspect of the invention is machine-readable code, such as stored in a memory associated with the server and run by a processor thereof and stored in a memory associated with the client device and run by a processor thereof, which is configured to implement the functionality/methods described below.

Referring still to FIG. 1, users may interface with the system 102, including the server 112. The users might interface via various clients or client devices 116,117. Such client devices might comprise non-mobile clients 116, such as a desktop computer, workstation or terminal. The clients might also comprise mobile clients 117. The mobile clients 117 may comprise, for example, a laptop computer, tablet, PDA, phone or the like. The clients 116, 117 preferably comprise at least one electronic video display for displaying training information, plus one or more user input devices such as a touch-screen, buttons, keyboard, mouse or the like. In one embodiment, the clients 116,117 may include a processor and machine-readable code (such as in the form of an “application”) which is executable by the processor to implement functionality

The database 110 stores information necessary to implement the functionality of the system, such as rulesets, ruleset versions, hackables (e.g. the player's one or more attackable devices and the opponent's one or more attackable devices), user personas, and other evaluation content. In one embodiment, the database 110 privately stores evaluation data for each session and each user. The database 110 may comprise a data storage device which is associated with a computing device, such as the server 112 (including ROM, RAM, hard drives, etc.), or may itself be associated with a computer having a processor.

The server 112 may comprise a computing device comprising a processor, a memory, a communication interface, and machine-readable code stored in the memory and executable by the processor to implement various of the functionality described herein. For example, the server may implement, via the executed software, a user management system, evaluation session management and a synchronization system, as well as scoring, analysis and reporting systems, as further described below. For example, in accordance with an aspect of the invention, the outcome of a game may be determined by the server 112 (and where a player or user's performance is evaluated, such as scored, such an evaluation may be performed via the server 112).

As indicated, the system 102 may include an evaluation dashboard 114. The server 112 may implement the evaluation dashboard 114 or it might be implemented by other devices. In one embodiment, the dashboard 114 is configured to display or provide user evaluation information. The dashboard 114 might thus comprise a graphical user interface with associated displayed information, such as generated by the server 112 and populated based upon information from the database 110. Such an evaluation dashboard 114 might be used by a trainer, evaluator or the like, such as to view and evaluate the outcomes of games and the level of training/competency of one or more players (such as by an administrator of a company relative to its employees).

In one embodiment, the server 112 and/or the client 116, 117 generates a game play interface. The game play user interface may, for example, be a web-based application providing settings, training plans and content management interfaces, user onboarding, management and analysis interfaces, as well as workforce population tracking and analysis interfaces, as further described herein.

Pipeline

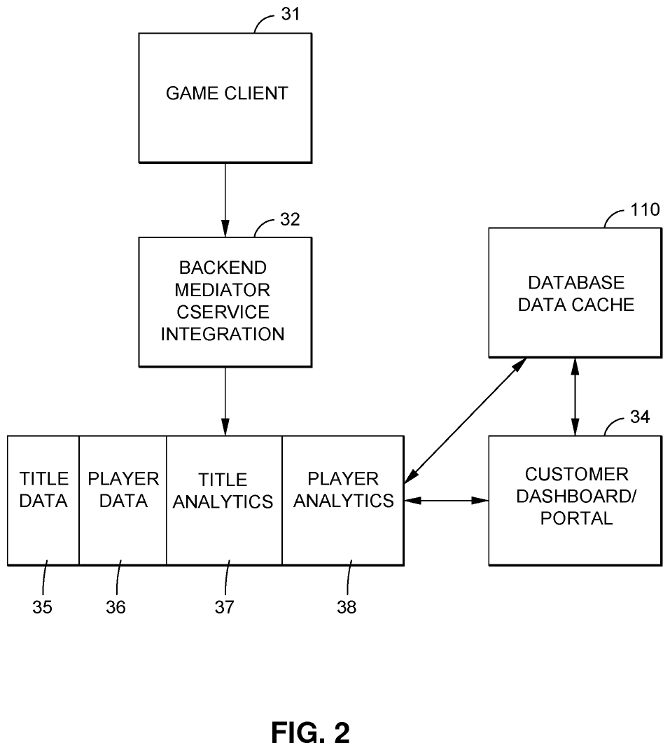

More details of the system 102 are depicted in FIG. 2. This figure illustrates an “information pipeline” of the system 102, including how information is generated and moves from generation point to enterprise customer utilization, including to both train a user and, as detailed below, provide cyber security “insight”—such as to an enterprise customer about their employees.

In one embodiment, internal databases are used in the modules depicted in FIG. 2. For example, a database module of the database 33 reflects the permanent storage of data to which enterprise users of the system have access, such as data regarding analytic events. In the preferred embodiment, a data cache module of the database 33 stores all player and title data. As an example, the data cache may permanently store what a user has chosen their “nickname” to be while the database module may permanently store how many times a user has clicked a certain game-related button.

The game client 31 generates a number of events, including but not limited to player-centric analytic events, player-centric data updates, title-centric analytic events, title-centric data updates, and other game related events during game play. Such events and updates pass to the system's mediation layer and backend mediator 32 (described in more detail below), which may be referred to as a “core.”

In one embodiment of the system, the core integrates 3^{rd} party services which manage the data storage and account management for users and game titles. To eliminate the need for system module modifications to make use of additional or changed internal/external services in future embodiments, the preferred embodiment uses the core to further integrate internal services, which manages data storage and account management.

All player profiles, player data, and app usage may be stored in database 33. To facilitate quicker account access each time the player returns to the game in a web browser, the core may use cookies stored on the player's client 116 device or mobile client 117. In one embodiment, the game client 31 module does not take action to save player data of any kind. From the core the data passes to the persistent, live storage services used by the application.

In one embodiment of the system, the player's game play analytics are stored in a temporary storage location for a certain period of time (such as 7 days) within database 33. After the designated time period, the player's data is aggregated and moved into the system's long-term store in database 33.

In one embodiment, player and title persistent data remain in the system database 33 for the life of the account/game title. Enterprise customers have access to analytics to run queries/analyses on players' data through an account portal (CAP) 34.

Every game client title that integrates with the core can contribute to the data perspective that enterprise customers would be interested in via the CAP 34. In one embodiment, intermediate calculations of the raw gameplay data are built into the game client 116, 117. In the preferred embodiment, these intermediate calculations of raw data are built into the core, which enables data to be collected from multiple game titles.

Detailed Architecture

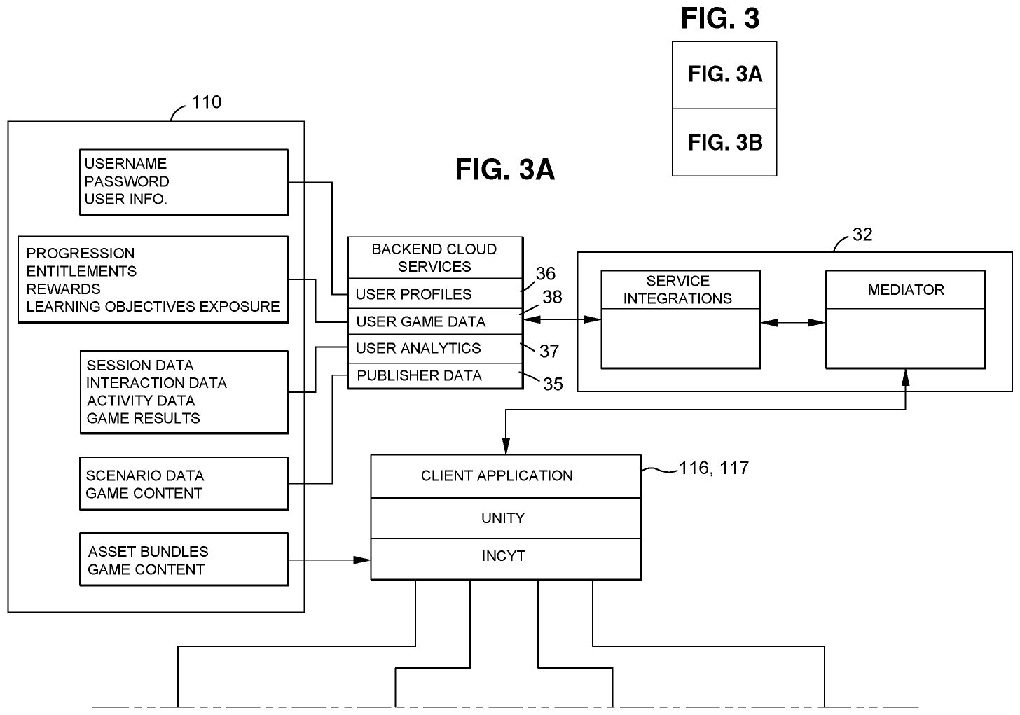

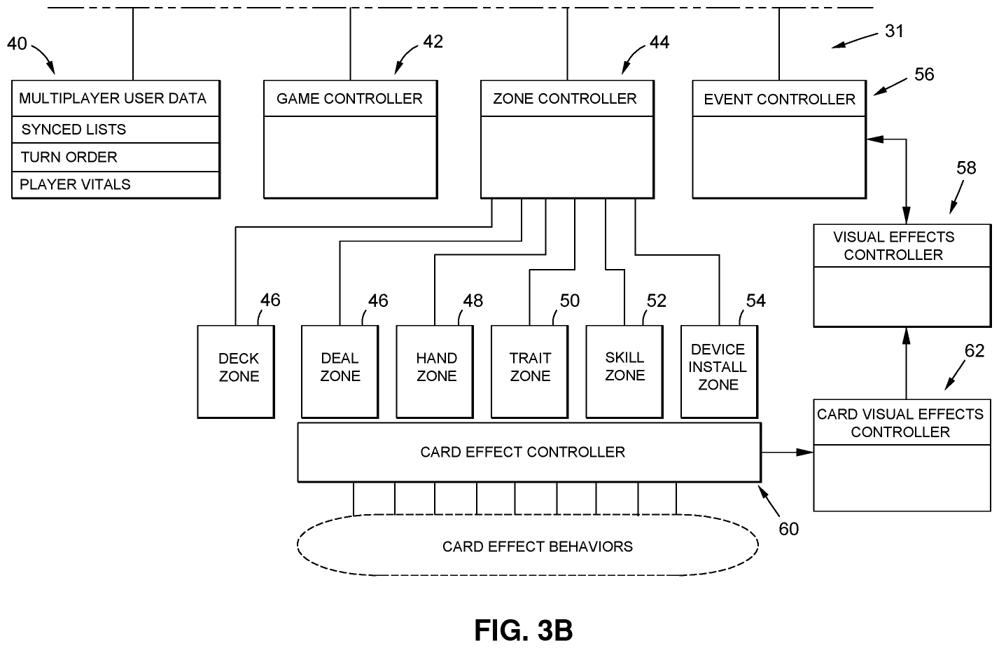

FIGS. 3A and 3B illustrate a more detailed architecture for an embodiment of the system 102 of the invention. This embodiment system 102 is configured to implement training based upon the use of entities, such as game cards, wherein the entities have components, such as attributes or effects. For example, game cards may comprise objects (such as files or other elements) in a computing system, where those objects have associated or assigned attributes or effects. In one embodiment, each player's ultimate goal is to use the entities, such as the game cards dealt or obtained by them, to take down (attack/destroy) their opponent's hackable devices.

As detailed herein, each player or user may be configured to be both a hacker and a defender simultaneously as game play unfolds. This integrative approach enables complex topics to be learned by way of game play against an interactive artificial intelligence driven opponent, which customizes the trainees training experience.

In one embodiment, the software architecture employs an “Entity, Component System” approach, where game cards are entities composed of an independent set of modular card effects or attributes. Any given game card can have N card effects, each implemented as an independent software module, further enabling game designers to specify and modify any card effects desired on any given card.

The system game card effects and game play mechanics present tension, urgency, key decision points, attacks, defenses, counter attacks, traps, misdirection, and more to players during game play.

The system further supports the ability to “mix and match” entities coupled with the other supported variations of data germane to a given game card effect. This flexibility enables the system to support a wide range of possible card representations. For example, variability in the different cards which are dealt during a game is a tool for making each game different.

In the preferred embodiment, the system supports a plurality of card effects with a plurality of card representations thus supporting game card expansion.

As an example, a game card defined as “Honey Pot 1” may comprise the composition of five (5) game effects. When a game designer desires to enhance the game by introducing a “Honey Pot 2” game card, the designer may simply copy “Honey Pot 1” game card and replace one of the original five (5) effects with a different effect (or add or subtract effects), thus expanding the game with a “Honey Pot 2” game card.

Game cards may have effects which last for different periods of time. For example, one or more game cards have effects that are “immediate”, e.g. causing an immediate effect or action. One or more other game cards might generate a permanent or persistent effect, such as by the game card resulting in the installation or implementation of a feature or effect which remains in effect for a duration of time, such as the entire game.

Game cards preferably represent a multitude of cyber security concepts on the offensive and/or defensive side, such as an offensive hack like phishing emails to defensive skills like phishing awareness training. The support for this interaction centers around moving game card objects from one area of the game (or zone) to another. Through repetition of interacting with the game cards and deploying them for their provided benefit (offensive or defensive), players gain an understanding of the cyber security concepts the cards represent.

Aspects of particular features of the system architecture will now be described.

Backend Cloud Services

Referring to FIGS. 3A and 3B, in one embodiment, the system 102 supports four major types of data comprising:

User profile data 36—containing users' account authentication info.

User game data 38—containing users' progression along a meta game experience, the entitlements the player has unlocked and rewards the play has earned along the way, and the player's exposure to cyber security awareness learning objects

User analytics 37—containing users' play session statistics, behavior and interaction activity data, and the results of their play sessions

Publisher data 35—containing details like card data and design; which includes the cyber security concepts the cards represent, and how those concepts are fictionalized during players' game play experiences

Service Integration and Mediator

As indicated above, the system 102 includes a mediator and service integration component 32. In one embodiment, backend services may be solutions implemented by 3^{rd} party providers which are integrated into the system, such as via a software development kit (SDK).

In one embodiment, the mediator integrates the support for all services the system implements with the backend services.

Game Client

In embodiment, the game client may comprise modules, such as one or more of a multiplayer user data module 40 and a game controller module 42.

In one embodiment, game cards are assigned to zones. A zone controller 44 may be provided which is configured to move game cards from one zone to another and maintain the game cards within the particular zone they will occupy. In one embodiment, at the start of the game, all game cards reside in a “deck zone” 46. Some cards are dealt or distributed to players, and are thus moved from the deck zone 46 to a “deal zone” 48. The dealt game cards may then be placed into a player's hand, e.g. in a “hand zone” 48. A player may then play a game card from their hand, at which point the game card is moved to or installed in another zone of the game while they remain active in the game world. These zones might comprise, for example, a “trait zone” 50 (comprising a location of game card traits that are in play), a “skill zone” 52 (comprising a location of game card skills that are in play) and a “device install zone” 54 (comprising a location corresponding to a permanent effect played against an opponent's device(s)), among others (for example, a discard zone may be provided, wherein once a game card is played or defeated and is no longer active in the game, it may be moved to the discard zone, and from there be moved back for shuffling into a deck for subsequent game play).

In one embodiment, an event controller 56 is provided. The event controller 56 may, for example, send and receive all the events for anything that happens in the game and route that information to the appropriate handlers, such as a card visual effects controller (CVEC) 62.

As indicated, the system 102 may include a CVEC 62, and may also include a visual effects controller (VEC) 58. These may comprise modules which implement the visual experience within the game, including implementing the visual effects of game cards' behaviors, such as rendering a game card, displaying movement of the game card (such as being dragged around the display), and graphically representing the game card defeating another game card.

In one embodiment, the system 102 includes a card effect controller (CEC) 60. As indicated above, the game cards represent cyber security concepts for player training, whereby the actual behavior of each individual game card may vary from one to another, such as based upon the particular cyber security concept that the game card is being used to train. The varied behaviors of the game cards are addressed by the CEC 60 and deployed as needed upon a game card at runtime.

In one embodiment, the CEC 60 and the CVEC 58 provide the game play behaviors (as associated with played game cards) presented to the players. The CEC 60 initializes all the effects on a card as it comes into play, sets up necessary monitoring, and executes the logical behaviors for each effect. The CVEC 58 listens/monitors for the events from the CEC 60 and queues up the necessary play of the relevant visual effects.

As an example, a game card may be configured to implement a skill type called Inspect Email Addresses, which renders its (in game) controller invulnerable towards Phishing Email attacks (another card), that could be played by opponents. As the Inspect Email Addresses game card enters the game world, the CEC 60 attaches to it all the necessary components (or behaviors) that it needs to stay in play, wait and listen from opponents to try and attack with their Phishing Email hacks, and then voids out those attempted Phishing Email attacks, leaving the “trained” owner of Inspect Email Addresses unharmed by the attempted attack.

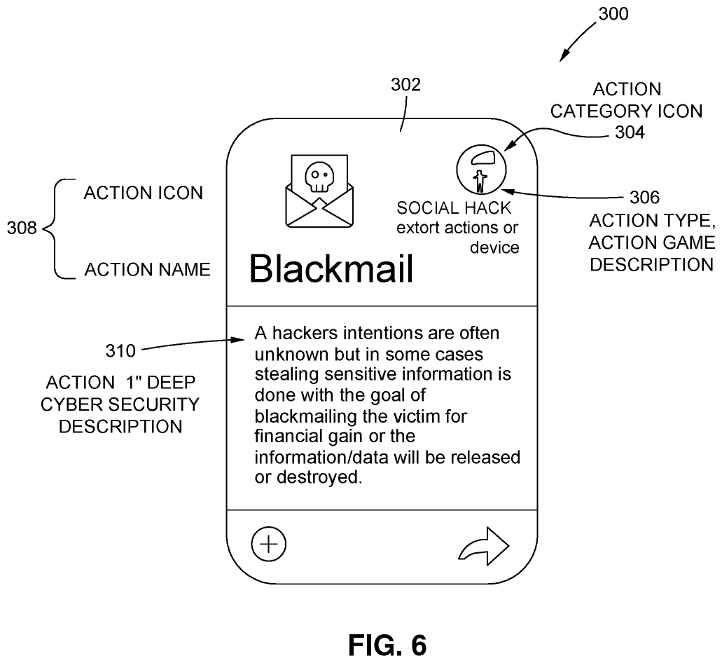

In one embodiment, game cards are graphically displayed to the players via their client device 116, 117. An example of a game card is illustrated in FIG. 6. The game card 300 may have a face 302 with associated information. In one embodiment, the associated information comprises one or more of:

1) A category icon 304. In one embodiment, different icons designate different card categories, which categories may comprise one or more of: a) recon hack; 2) damage hack; 3) infiltrate hack; 4) social hack; 5) restore; 6) visibility; 7) skill; 8) event; and 9) defense.

2) A designated action type and description 306.

3) An action icon and name 308. In one embodiment, different icons designate different actions or attributes relative to a particular category. For example, as illustrated in FIG. 6, one action within the category of “social hack” may comprise the “Blackmail” action. Play of this card thus causes the system to implement the “Blackmail” action. Other icons and names may relate to skill actions, defense actions and the like.

4) Cyber-security event information 310. In one embodiment, the game card 300 may include information regarding the particular action (whether it is an offensive action such as a recon hack, social hack, etc.) or a skill or a defensive action, whereby the player is able to learn the nature of the action and its associated attributes.

As described herein, one embodiment of the invention is a multi-player training game. The game is preferably played by two (or more, including where the players may play in teams) live players who play against one another. However, in one or more embodiments, the game might be played or presented as between a single live player against a non-live opponent, such as an AI opponent.

In such an embodiment of the system, the AI opponent may be dealt or acquire game cards and play game cards just like a live player. The AI opponent may be implemented in various manners, and may weigh potential outcomes of all potential actions “in hand” at the time the AI choosing an action to play.

Aspects of Game Play

In one embodiment, the system 102 effectuates training by presentation and play of a cybersecurity training game. As indicated above, in one embodiment, the game includes entities, such as game cards, wherein the entities have components, such as attributes or effects. Thus, in one embodiment, the game is presented and played using cards dealt to (or otherwise obtained by) each player, such as from a set of cards. The cards each have various associated attributes or effects which are associated with cybersecurity topics.

In one embodiment, the game comprises a turn-based game in which two players take turns playing cards. Each player's objective is to attack and destroy one or more devices belonging to the player before the other player attacks and destroys their own devices, using game cards that are dealt to or acquired by them.

In one embodiment, game cards are assigned to zones and the assigned zone of a card is updated, such as based upon it being dealt or played, as noted above.

In one embodiment, a player is trained on a number of campaigns or topics. Each of these topics may introduce or train on one or more concepts, and may have one or more associated game mechanics and game actions (as tied to game cards) wherein the game actions relate to the topic being trained. In one embodiment, game actions are unlocked in association with each campaign or topic, whereby a player is introduced to a number of new actions relative to each topic, with the game actions being cumulative.

In one embodiment, the topics or campaigns may comprise (but are not limited to those noted below or might comprise other topics or campaigns):

Subject 1: Cyber Security Safety

Subject 2: Phishing

Subject 3: Social Media

Subject 4: Infiltration

Subject 5: Password Security

Subject 6: Hacker

Subject 7: Red Team/Blue Team

Subject 8: Hunter

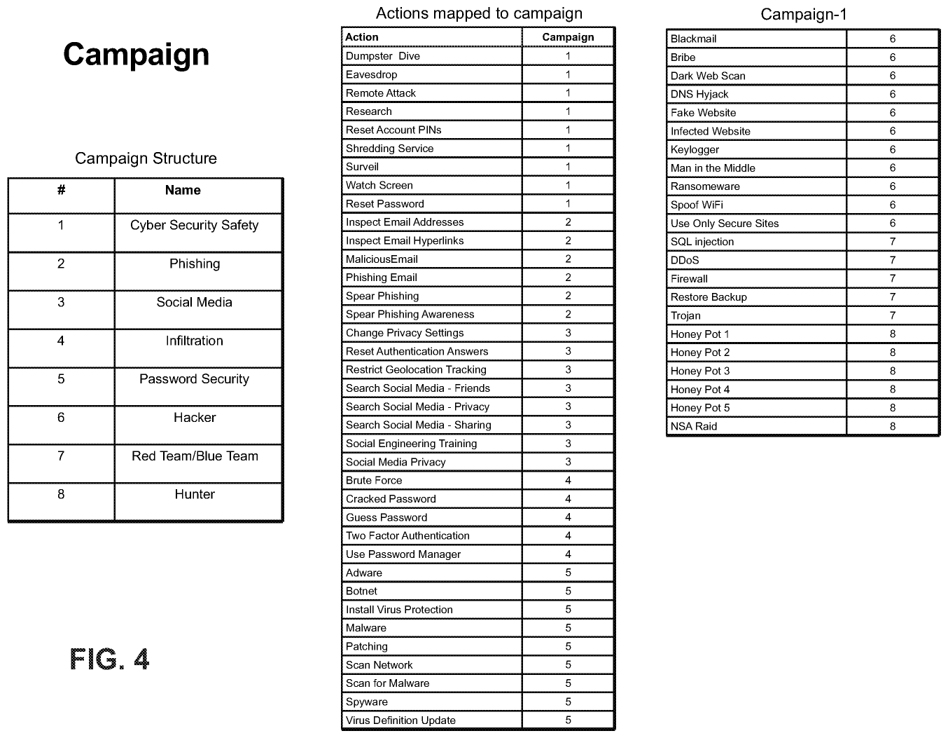

FIG. 4 illustrates one embodiment of a mapping of game actions (which game actions are mapped or tied to particular game cards for use in presenting a game on the topic/campaign).

As indicated above, the game may be played by a player against another live player or against an AI opponent, wherein the player may take offensive or defensive actions. For the AI opponent(s), each AI opponent includes all of the same options as human players. The AI player determines the action to take during gameplay through a heuristic evaluation function that searches through the subset of all options presented and chooses the highest scoring (probability) potential action.

In embodiment, the outcome of the game may be declared relative to the first player to successfully hack or destroy their opponent's devices (wherein that player is the winner of the game and the other player is then the loser of that game).

However, in other embodiments, each player may be scored, such as based upon their actions. The scores for individual potential actions may have a base (starting) value, or weight, that is provided by the game designers and leveraged to present both intelligent and personality tendencies. In one embodiment, other aspects of the invention include the use of metrics and analytics as described in U.S. application Ser. No. 16/172,276, filed Oct. 26, 2018, titled “Method and System for Evaluating Individual and Group Cyber Threat Awareness”, which is incorporated herein in its entirety by reference.

Simplified and Traditional Cybersecurity Kill Chain

In one embodiment, aspects of the training implemented by the system is based on or emphasizes the cybersecurity kill chain, namely:

(1) Action on Objective

(2) Command and Control

(3) Intrusion

(4) Exploit

(5) Delivery

(6) Weaponize

(7) Reconnaissance

In one embodiment, the game play involves three major aspects:

1. Player gathers Intel (e.g. obtains opponent information);

2. Player uses the intel to find an “in” or “infiltrate” the opponent's devices; and

3. Once the player has gained access to the opponent's resource, the player can attack the opponent's devices.

### Game Play Example

The following are highlights of an example game play session. In one embodiment, screen images, such as graphical images or interfaces are preferably displayed to the player via their client device 116 or mobile device 117.

In one embodiment, each player's environment has three layers or zones: (1) a skill layer, (2) an information layer, and (3) an infiltration layer. Each player starts with three (3) information slots filled with personal information, two (2) hackable or attackable devices, two (2) open install slots, and eight (8) open skills slots. The information slots are associated with the information layer. The hackables and the install slots are associated with the infiltration layer, and the skill slots and any associated skills are associated with the skill layer.

In one embodiment, the information data which is associated with the information slots is a representation of Personable Identifiable Information(PII), and in one embodiment is generic and not specific to any action and does not have relevance to the game play.

The goal of the game is to destroy the opponent's hackable devices by penetrating the information layer to install attacks at the infiltration or install layer, in order to attack the opponent's hackable devices before the opponent does the same to the player's devices (and wherein the player and opponent may both engage in defensive actions with the goal of thwarting or slowing an attack by their opponent).

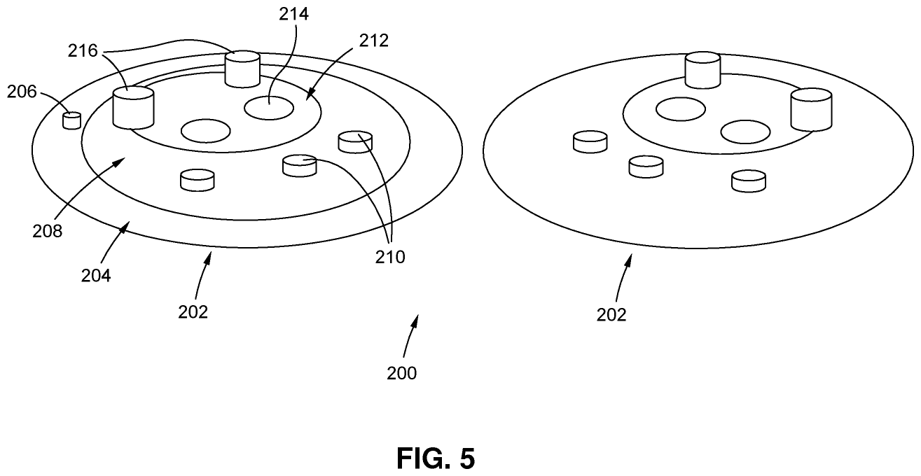

As illustrated in FIG. 5, the game may be presented with respect to a game environment 200. This environment may comprise a graphically rendered display or interface. The environment 200 may include a game board 202 for each player. The game board 202 may define the skill layer 204 and one or more associated skills 206, the information layer 208 and the associated information slots or information data 210, the infiltration layer 212 and associated install slots 214, and the players hackable devices 216. Of course, various graphics might be used to display the game information, including the game boards 202. For example, in the illustrated embodiment, the game boards 202 for each player comprise generally circular game boards with the different layers comprising concentric ring portions of the game board. Of course, the game boards might have various other shapes and configurations.

Each player is dealt one or more game cards for use in the game. In one embodiment, each player has a hand with five (5) openings and may fill those openings with cards which are dealt to them or cards which they otherwise acquire during game play. In one embodiment, each player is initially dealt three (3) game cards. As indicated herein, each game card and its associated attributes or effects, may vary. The actions that are associated with the game cards can vary from attacks to discover information, skills that can block specific attacks, installs both offense and defense that affect other actions that can be recurring until removed, remote attacks and general visibility/event style attacks. The game cards, game hands and the like are preferably rendered to each player graphically in their game environment 200 (wherein a player can see their hand and associated cards, but cannot see those of the opponent).

In general, game card “actions” are played by a player when they drag a game card to their game board or the opponent's game board (such as by providing input to their client device 116, 117, such as by a touch-screen, mouse, etc.) Generally, a player can play as many actions as they can from their hand each turn (unless, in one embodiment, one or more actions cause a player to lose their turn).

In one embodiment, a player can play a “discover opponent's information” action at any time. In one embodiment, a player can play a defensive action at any time, so long as the opponent has not already installed an attack prior to the installation of the defense.

Once a player successfully exposes or compromises at least one information slot of the opponent, the infiltration or install layer of the opponent is exposed, allowing them to install an offensive action. The step of compromising an opponent's information slot may be graphically displayed as removal of one or more of the information objects 210 from the information layer 208 (thus leaving, for example, a graphically rendered open position or slot).

A player can play a “Restore Information Actions” to replenish one of their information slots, thus forcing the opponent to play a “discover opponent's information” again before they can access their install slots.

A player can play a “Restore Install Actions” to remove all opponent installs of attacks from their infiltration/install layer, thus negating any recurring outcomes of such an installed attack.

In one embodiment, adding “skill actions” will block certain actions called out in the skill. Up to eight (8) skills may be added by a player. These may be shown as the skill objects 206 which are associated with the player's skill layer or zone 204. For example, a player's skill may block an action associated with a game card which is played by the opposing player. In one embodiment, game cards with associated skill actions are played like any other game card, causing the skill to get added to an open skill slot. In one embodiment, once a skill is added, it cannot be removed. Further, in one embodiment, each skill blocks a specific action, e.g. once the skill “Spear Phishing Training” is added, that skill will always block a Spear Phishing Action played by the opponent. Further, in one embodiment, skills are hidden to the opponent unless exposed by the play of a corresponding action by the opponent, or unless a “Scan Action” or other reveal action is played by the opponent that reveals all installed skills.

Skills are also hidden unless exposed once they block a specific attack, or a Scan Action is played that reveals all current skills acquired.

In one embodiment, once a player has successfully compromised all three (3) of their opponents information slots, the opponent's hackable devices are now vulnerable to “Remote Attacks”. In one embodiment, until and unless an opponent exposes or compromises all three(3) of the information data/slots of the opposing player, the opposing player's hackable devices are not vulnerable to direct remote attacks. In other embodiments, certain game cards may employ actions that can bypass that exposure and force the destruction of the opponent's device(s).

A remote attack can only be blocked by an installed “Defense Firewall Action” essentially acting as an additional device.

Once a hackable device has been destroyed it can be recovered with “Restore Backup Action.” However once both of a player's hackable devices are destroyed, the game is over.

In one embodiment, because a player gets dealt three (3) cards each turn or round, if a player cannot play all of their cards in a single round, the player may accumulate game cards. In addition, in one or more embodiments, certain actions may result in the player stealing game cards from the opponent. In one embodiment, however, the player's hand may only hold five (5) total game cards. Thus, there may well be times when the player will have to discard game cards to remain under the five (5) game card limit. This discard process causes the player to have to make strategic decisions on what to discard or keep depending on how each players defense and situation is set up. In one or more embodiment, a player may play one or more game cards that effectively block or occupy slots of the opponent. For example, a player might play an “Adware Install” game card that can occupy a hand slot of the opponent, thus preventing the opponent from using that hand slot(s) (until, for example, the blocking card is removed via a “Scan for Malware” or “Update Software” or other game card).

In one embodiment, all game slots are reset between games so that no skills carry over to a subsequent game. However, in other embodiments, a player might be permitted to collect and carry certain skills from one game to another.

Of course, the game might have other variations and features. For example, the game might have other layers (including a greater or lesser number of layers). The game might also be played with a single player hackable or attackable device, or more than two. The game might also allow for a greater or lesser number of skills, information elements and the like.

It one embodiment, the game might be played relative to a physical game board, such as with game pieces that designate the player hackable devices, information elements, skill elements and the like, and physical/printed game cards.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A system for implementing cyber-security awareness training to a player in the form of a turn-based game, comprising:
a client device comprising a processor, a video display and a player input device;
a system server comprising a system server processor and a system server memory, said system server in communication with said client device;
non-transitory machine-readable code stored in said system server memory and executable by said system server processor of said system server to:
cause said client device to display a player game board, said player game board having a plurality of layers and at least one attackable asset of said player, and to display an opponent game board, said opponent game board having a plurality of layers and at least one attackable asset of said opponent;
cause said client device to display a player hand of one or more game cards, each of said game cards having at least one cyber-security related attribute;
to, in a plurality of alternating turns:
receive input from said player of said player device of one of said game cards to play;
implement said at least one cyber-security related attribute associated with said played game card relative to one of said layers of said player game board or said opponent game board; and
implement at least one cyber-security related attribute associated with at least one game card played by said opponent relative to one of said layers of said player game board or said opponent game board; and
determine said player to be a winner of said game when the player successfully attacks said at least one attackable asset of said opponent before said opponent successfully attacks said at least attackable asset of said player, and determine said opponent to be the winner of said game when the opponent successfully attacks said at least one attackable assets of said player before said player successfully attacks said at least one attackable asset of said player;
wherein in order to successfully attack said at least one attackable asset of said player, said opponent must penetrate one or more layers of said player's game board via said at least one game card played by said opponent, and wherein in order to successfully attack said at least one attackable asset of said opponent, said player must penetrate one or more layers of said opponent's game board via said at least one game card played by said player.

2. The system in accordance with claim 1, wherein said player hand of one or more game cards comprises at least one of: a game card dealt to said player and a game card acquired by said player from said opponent.

3. The system in accordance with claim 1, wherein said layers of said player's game board and said opponent's game board comprise a skill layer, an information layer and an infiltration layer.

4. The system in accordance with claim 3, wherein one or more elements of player information are associated with said information layer of said player's game board and one or more elements of opponent information are associated with said information layer of said opponent's game board.

5. The system in accordance with claim 4, wherein the player must obtain said one or more elements of opponent information in order to attack said at least one attackable asset of said opponent.

6. The system in accordance with claim 5, wherein the player obtains said one or more elements of opponent information based upon the play of one or more of said game cards.

7. The system in accordance with claim 1, wherein said game cards are associated with a deck of game cards.

8. The system in accordance with claim 7, wherein the game cards associated with the deck of game cards varies depending upon a cyber-security skill being trained.

9. The system in accordance with claim 1, wherein said at least one cyber-security related attribute associated with said game card may comprise an offensive attribute or a defensive attribute.

10. The system in accordance with claim 9, wherein when said game card played by said player has a defensive attribute, associating said attribute with said player's game board.

11. The system in accordance with claim 1, wherein said non-transitory machine-readable code stored in said system server memory and executable by said system server processor of said system server is configured to associated each game card with a card zone depending upon a state of play of said game card.

12. The system in accordance with claim 11, wherein said card zones comprise at least two of: a deck zone, a deal zone, a hand zone and an install zone.

13. The system in accordance with claim 1, wherein said non-transitory machine-readable code stored in said system server memory and executable by said system server processor of said system server implements a card effect controller, said card effect controller implementing the one or more attributes associated with each played card.

14. The system in accordance with claim 1, wherein said machine-readable code causes said server to implement at least one cyber-security related attribute by causing said client device to display a change in a visual appearance of said game board.

15. The system in accordance with claim 1, wherein said opponent comprises a live player.

16. The system in accordance with claim 1, wherein said opponent comprises an artificial intelligence opponent.

17. A method of training cyber-security awareness to first and second players via a game, comprising the steps of:
causing a client device of said first player and a client device of second player to each to display a game interface, said game interface comprising a first player game board having a plurality of layers and at least one attackable asset of said first player, and a second player game board having a plurality of layers and at least one attackable asset of said second player;
providing, by a game server, one or more game cards to each of said first and second players, each of said game cards having at least one cyber-security related attribute;
presenting a plurality of game turns comprising:
receiving, at said game server from said first player, via input from said first player to said client device of said first player, one of said game cards to play;
implementing, via said server, said at least one cyber-security related attribute associated with said game card played by said first player relative to one of said layers of said first and/or second player game boards; and
receiving, at said game server from said second player, via input from said second player to said client device of said second player, one of said game cards to play; and
implementing, via said server, said at least one cyber-security related attribute associated with said game card played by said second player relative to one of said layers of said first and/or second player game boards; and
determining an outcome of said game, wherein said first player is determined to be a winner of the game when the first player successfully attacks said at least one attackable asset of said second player before said second player successfully attacks said at least attackable asset of said first player, and wherein said second player is determined to be the winner of the game when the second player successfully attacks said at least one attackable asset of said first player before said first player successfully attacks said at least one attackable asset of said second player;
wherein in order to successfully attack said at least one attackable asset of said first player, said second player must penetrate one or more layers of said first player's game board via said at least one game card played by said second player, and wherein in order to successfully attack said at least one attackable asset of said second player, said first player must penetrate one or more layers of said second player's game board via said at least one game card played by said first player.

18. The method in accordance with claim 17, wherein said at least one cyber-security attribute may comprise an offensive attribute having an offensive effect, or a defensive attribute having a defensive effect.

19. The method in accordance with claim 18, further comprising updating said game interface based upon said offensive effect or said defensive effect.

20. The method in accordance with claim 17, wherein said layers of said first player's game board and said layers of said second player's game board each comprise a displayed skill layer, a displayed information layer and a displayed infiltration layer.
